(19) United States
(12) Patent Application Publication
(10) Pub. No.: US 2022/0290676 A1
(43) Pub. Date: Sep. 15, 2022

(54) CROSS FLOW FAN, LIFT GENERATION DEVICE PROVIDED WITH SAME, AND AIRCRAFT PROVIDED WITH SAME

(71) Applicant: MITSUBISHI HEAVY INDUSTRIES, LTD., Tokyo (JP)

(72) Inventors: Kazuhiro IMAI, Tokyo (JP); Yuki MORISAKI, Tokyo (JP); Masayuki ODA, Tokyo (JP); Yasuhiro SAIKI, Tokyo (JP)

(21) Appl. No.: 17/632,964

(22) PCT Filed: Feb. 6, 2020
(86) PCT No.: PCT/JP2020/004591

§ 371 Date: Feb. 4, 2022

(30) Foreign Application Priority Data
Aug. 29, 2019 (JP) 2019-156887

(51) Int. Cl. F04D 17/04; B64C 21/06

(52) U.S. Cl. CPC F04D 17/04; B64C 21/06; B64C 2230/04

(57) ABSTRACT

A cross flow fan includes a plurality of vanes arranged around a rotation axis at predetermined intervals in the circumferential direction, a tongue section arranged on the outer circumferential side of the vanes, and jetting sections that jet a fluid along the wall surfaces of a discharge path into which the fluid is discharged from each of the vanes. A facing wall section is provided to a position facing the tongue section with the vanes therebetween. The facing wall section is provided with: an upstream wall section configured so as to be equivalent to the radius of curvature in the outer circumference of a path formed when the vanes rotate; a downstream wall section that is connected to the upstream wall section and in which the radius of curvature gradually becomes larger than that of the upstream wall section; and a diffuser wall section connected to the downstream wall section.

### TECHNICAL FIELD

The present disclosure relates to a cross flow fan, a lift generation device including the cross flow fan, and an aircraft including the lift generation device.

### BACKGROUND ART

PTL 1 discloses a cross flow fan that improves lift by sucking a boundary layer on an upstream side of an airframe surface of an aircraft.

### CITATION LIST

### Patent Literature

[PTL 1] US Unexamined Patent Application Publication No. 2017/0267342

### SUMMARY OF INVENTION

### Technical Problem

The cross flow fan forms a circulation vortex on a vane side that is rotated by a tongue portion. The circulation vortex does not perform any work and is an area where a flow speed is lower than in other regions. For this reason, the cross flow fan has a problem in that increasing flow rate is relatively difficult because of the presence of the circulation vortex.

In addition, a stagnation region is likely to be formed in the vicinity of a wall surface of a flow path on a downstream side of a vane, and thus there is a possibility that a fluid loss increases.

The present disclosure is devised in view of such circumstances, and an object thereof is to provide a cross flow fan that can reduce a fluid loss, a lift generation device including the cross flow fan, and an aircraft including the lift generation device.

### Solution to Problem

According to an aspect of the present disclosure, in order to solve the problem, there is provided a cross flow fan including a plurality of vanes that are disposed at a predetermined interval in a circumferential direction about a rotational axis, a tongue portion that is disposed on an outer circumferential side of the vane, and a jetting portion that jets a fluid along a wall surface of a discharge flow path to which the fluid is discharged from each of the vanes.

### Advantageous Effects of Invention

Since the jetting portion that jets a fluid along the wall surface of the discharge flow path to which the fluid is discharged from the vanes is provided, a fluid loss can be reduced as much as possible.

### BRIEF DESCRIPTION OF DRAWINGS

FIG. 1 is a plan view showing an aircraft including a cross flow fan of the present disclosure.

FIG. 2 is a cross sectional view showing a cross flow fan according to a first embodiment of the present disclosure.

FIG. 3 is a cross sectional view showing a cross flow fan according to a second embodiment of the present disclosure.

### DESCRIPTION OF EMBODIMENTS

Hereinafter, embodiments according to the present disclosure will be described with reference to the drawings.

### First Embodiment

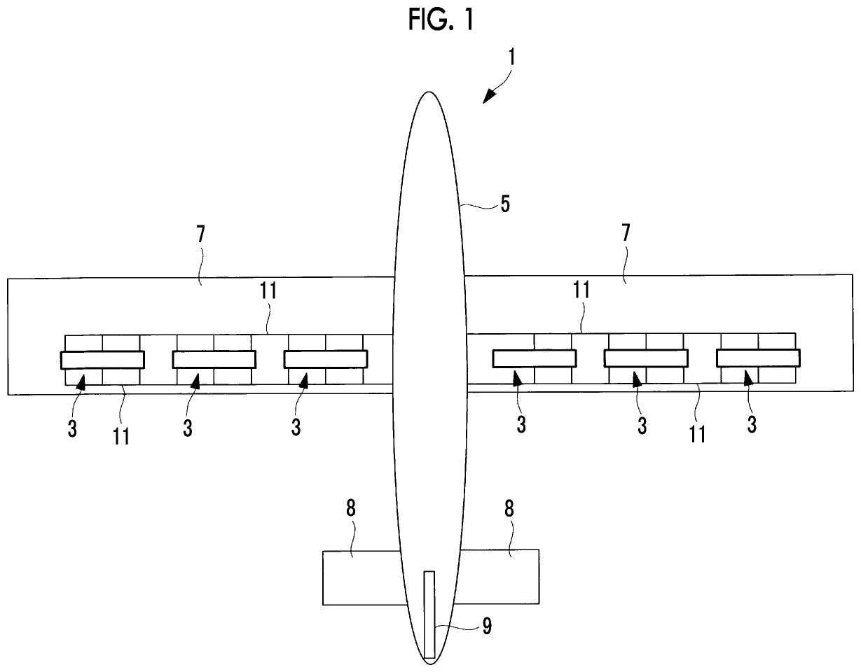

Hereinafter, a first embodiment of the present disclosure will be described. FIG. 1 shows an aircraft 1 including a cross flow fan 3 used as a lift generation device.

The aircraft 1 includes main wings 7 provided on each side portion of a fuselage 5. A horizontal stabilizer 8 and a vertical stabilizer 9 are included at a rear part of the fuselage 5. A turbojet engine (not shown) is provided at each main wing 7 as a propeller.

Three cross flow fans 3 are provided at each of the right and left main wings 7. However, the number of the cross flow fans 3 may be any number, and may be one or two, or may be four or more. The cross flow fans 3 are provided on a trailing edge side of the main wing 7. By sucking air flowing in the vicinity of a wall surface of the main wing on an upstream side, the cross flow fans 3 suppress delamination by a boundary layer flow flowing on an upper surface (outer surface) of the main wing 7 and achieve an increase in lift.

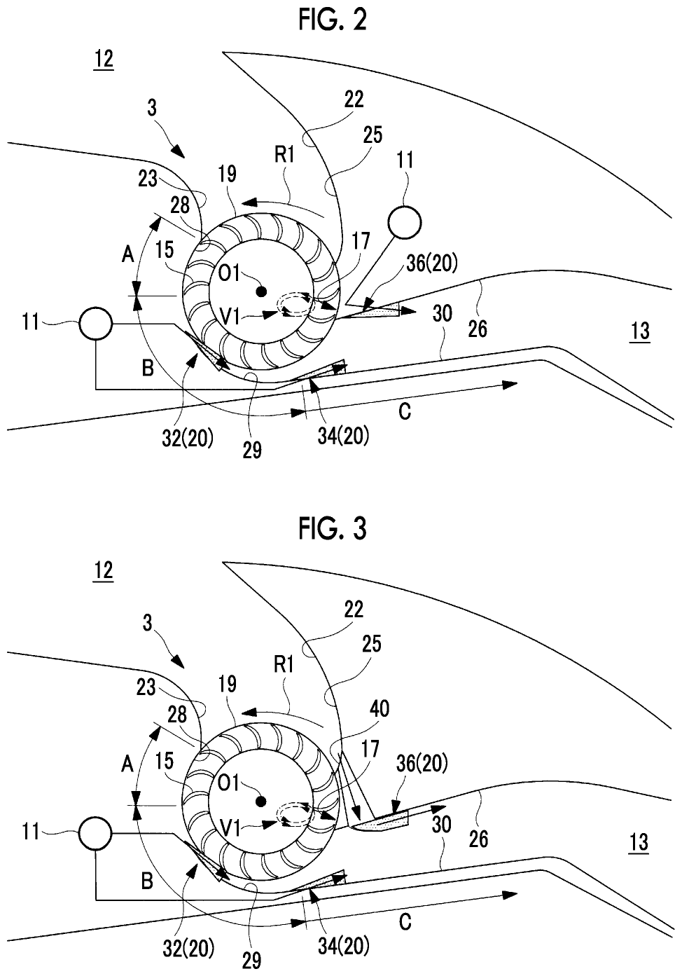

A compressed air supply passage 11 through which compressed air (compressed fluid) is supplied is connected to each of the cross flow fans 3. The compressed air is jetted from a jetting portion 20 (see FIG. 2) provided in the cross flow fan 3. The compressed air supply passage 11 is connected to an air compressor (not shown). The air compressor may be a dedicated air compressor, or may be an air compressor of the turbojet engine. In a case of using the air compressor of the turbojet engine, the air compressor performs extraction of some of the air. Although the compressed air supply passage 11 is connected to each of the cross flow fans 3 in an axial direction (right-and-left direction in FIG. 1) at three places in FIG. 1, the number is not limited thereto.

FIG. 2 shows a cross section of the cross flow fan 3. The cross flow fan 3 is disposed in an air passage formed by a tongue portion side wall member 22 provided with a tongue portion 17 and a facing wall member 23 facing the tongue portion side wall member 22.

At a front part of the cross flow fan 3, for example, a suction port 12 formed in a slot shape is provided. At a rear part of the cross flow fan 3, for example, a discharge port 13 formed in a slot shape is provided. The cross flow fan 3 sucks air from the suction port 12, and discharges the air from the discharge port 13.

The cross flow fan 3 includes a plurality of vanes 15 disposed at predetermined intervals in a circumferential direction about a rotational axis O1. Each of the vanes 15 has the same section in a direction perpendicular to the plane of the paper in FIG. 2 and extends. The vanes 15 are connected to each other by a ring-shaped frame body 19. Each of the vanes 15 rotates in a rotation direction R1 (counterclockwise in FIG. 2) about the rotational axis O1. Each of the vanes 15 is rotationally driven by a vane drive motor (not shown).

As shown in FIG. 2, the tongue portion 17 is disposed on an outer circumferential side of each of the vanes 15. The tongue portion 17 is provided at an intermediate position on the tongue portion side wall member 22, and is formed in a shape protruding to a vane 15 side. The tongue portion side wall member 22 includes a tongue portion upstream wall member 25 that is provided on an upstream side of the tongue portion 17 and a tongue portion downstream wall member 26 that is provided on a downstream side of the tongue portion 17.

The tongue portion upstream wall member 25 has a shape in which a downstream side thereof is connected to the tongue portion 17 and an upstream side thereof is curved toward a front part of the main wing 7. The tongue portion upstream wall member 25 is connected to the suction port 12.

The tongue portion downstream wall member 26 has an upstream side connected to the tongue portion 17 and a downstream side connected to the discharge port 13. In this manner, the tongue portion downstream wall member 26 configures a wall surface of a discharge flow path to which air (fluid) is discharged from the vanes 15, and forms a diffuser region where pressure recovery is performed, together with a diffuser wall member 30.

The facing wall member 23 includes an upstream wall member 28 provided on a suction port 12 side, a downstream wall member 29 connected to the upstream wall member 28, and the diffuser wall member 30 connected to the downstream wall member 29.

The upstream wall member 28 has a shape with an equivalent curvature radius with an outer circumference of a trajectory formed when the vanes 15 rotate, at a region (see a region A of FIG. 2) adjacent to the vanes 15. Therefore, a gap with outer circumferences of the vanes 15 is constant in the region A of the upstream wall member 28.

The downstream wall member 29 is provided over a region B, and has a shape of which a curvature radius becomes gradually larger than that of the region A of the upstream wall member 28. Therefore, a gap with the outer circumferences of the vanes 15 gradually increases in the region B of the downstream wall member 29. In this manner, the downstream wall member 29 configures a wall surface of the discharge flow path to which air is discharged from the vanes 15.

The diffuser wall member 30 is provided over a region C, and has a curvature radius discontinuously changing with respect to a curvature radius of a downstream end of the region B of the downstream wall member 29. The diffuser wall member 30 has a substantially linear shape toward the downstream side. In this manner, the diffuser wall member 30 configures a wall surface of the discharge flow path to which air is discharged from the vanes 15.

A first jetting portion (jetting portion) 32 that jets compressed air guided from the compressed air supply passage 11 is provided on the downstream wall member 29. The first jetting portion 32 is preferably provided on the upstream side of the downstream wall member 29, and is more preferably provided at a most upstream position on the downstream wall member 29. The air jetted from the first jetting portion 32 flows on a wall surface of the downstream wall member 29. The shape of a jetting opening of the first jetting portion 32 may be a circular shape or a slot shape.

A second jetting portion (jetting portion) 34 that jets compressed air guided from the compressed air supply passage 11 is provided on the diffuser wall member 30. The second jetting portion 34 is preferably provided on the upstream side of the diffuser wall member 30, and is more preferably provided at a most upstream position on the diffuser wall member 30. The air jetted from the second jetting portion 34 flows on a wall surface of the diffuser wall member 30. The shape of a jetting opening of the second jetting portion 34 may be a circular shape or a slot shape.

A third jetting portion (jetting portion) 36 that jets compressed air guided from the compressed air supply passage 11 is provided on the tongue portion downstream wall member 26. The third jetting portion 36 is preferably provided on the upstream side of the tongue portion downstream wall member 26, and is more preferably provided at a most upstream position on the tongue portion downstream wall member 26. The air jetted from the third jetting portion 36 flows on a wall surface of the tongue portion downstream wall member 26. The shape of a jetting opening of the third jetting portion 36 may be a circular shape or a slot shape.

The cross flow fan 3 described above operates as follows.

In accordance with a command of a control unit (not shown), the vane drive motor is driven and each of the vanes 15 is rotated about the rotational axis O1.

Due to action of the tongue portion 17, a circulation vortex V1 is formed between the rotational axis O1 and the tongue portion 17. The circulation vortex V1 rotates counterclockwise in FIG. 2. As the circulation vortex V1 is formed, a mainstream flow from the suction port 12 side toward the discharge port 13 across the cross flow fan 3 is formed.

In accordance with a command of the control unit (not shown), compressed air is jetted from the first jetting portion 32. The jetted compressed air flows along the wall surface of the downstream wall member 29.

In accordance with a command of the control unit (not shown), compressed air is jetted from the second jetting portion 34. The jetted compressed air flows along the wall surface of the diffuser wall member 30.

In accordance with a command of the control unit (not shown), compressed air is jetted from the third jetting portion 36. The jetted compressed air flows along the tongue portion downstream wall member 26.

Operational effects of the present embodiment described above are as follows.

The jetting portion 20 (32, 34, and 36) that jets air along a wall surface of the discharge flow path to which the air is discharged from the vanes 15 is provided. Accordingly, a flow can be formed in a fluid loss region such as a low pressure region and a stagnation region formed in the vicinity of the wall surface of the discharge flow path, and a fluid loss can be reduced as much as possible.

Since the upstream wall member 28 has an equivalent curvature radius with the outer circumference of the trajectory formed when the vanes 15 rotate, a gap between the outer circumferences of the vanes 15 and the upstream wall member 28 is constant, and the loss of a fluid in this region is small. However, since the downstream wall member 29 connected to the upstream wall member 28 has a curvature radius becoming gradually larger than that of the upstream wall member 28, a gap between the outer circumferences of the vanes 15 and the downstream wall member 29 gradually increases. For this reason, there is a possibility that a fluid loss increases in the downstream wall member 29. Thus, the first jetting portion 32 that jets a fluid along the wall surface of the downstream wall member 29 is provided. Accordingly, the fluid loss can be reduced.

The diffuser wall member 30 is connected to the downstream wall member 29, and has a curvature radius that is even larger than the downstream wall member 29 in order to perform pressure recovery. For this reason, there is a possibility that delamination of a flow occurs in the vicinity of a wall member of the diffuser wall member 30 and that a fluid loss increases. Thus, the second jetting portion 34 that jets a fluid along the wall surface of the diffuser wall member 30 is provided. Accordingly, the fluid loss can be reduced.

There is a possibility that a fluid loss increases in the vicinity of the tongue portion downstream wall member 26 because of an effect of the circulation vortex V1. Thus, the third jetting portion 36 that jets a fluid along the wall surface of the tongue portion downstream wall member 26 is provided. Accordingly, the fluid loss can be reduced.

Although the first jetting portion 32, the second jetting portion 34, and the third jetting portion 36 are shown as the jetting portions in the present embodiment, any one of the jetting portions may be used, or two jetting portions selected from the three jetting portions may be used.

### Second Embodiment

Next, a second embodiment of the present disclosure will be described with reference to FIG. 3.

The present embodiment is different from the first embodiment in that air is introduced into the third jetting portion 36. Since other parts are the same as in the first embodiment, description thereof will be omitted.

As shown in FIG. 3, a fluid introduction inlet 40 is formed in the tongue portion upstream wall member 25. The fluid introduction inlet 40 is provided on the upstream side from the vanes 15. The fluid introduction inlet 40 is connected to the third jetting portion 36. Air introduced from the fluid introduction inlet 40 flows from the third jetting portion 36 along the wall surface of the tongue portion downstream wall member 26.

Operational effects of the present embodiment described above are as follows.

By forming the fluid introduction inlet 40 in the tongue portion upstream wall member 25, which is on the upstream side from the vanes 15, air is introduced. Since the cross flow fans 3 are provided at the main wing 7 of the aircraft 1, the air can be introduced from the fluid introduction inlet 40 using a dynamic pressure. Since the air introduced from the fluid introduction inlet 40 is jetted from the third jetting portion 36, it is not necessary to generate power, which generates high-pressure air. For this reason, an additional structure is unnecessary, and thus the weight can be reduced.

Although the first jetting portion 32, the second jetting portion 34, and the third jetting portion 36 are shown as the jetting portions in the present embodiment, any one of the jetting portions may be used, or two jetting portions selected from the three jetting portions may be used.

In addition, although the fluid introduction inlet 40 in which a dynamic pressure is used is connected to the third jetting portion 36 in the present embodiment, air may be supplied to the first jetting portion 32 and the second jetting portion 34 by providing the fluid introduction inlet 40 at an appropriate position where the dynamic pressure can be used.

In addition, the position of the fluid introduction inlet 40 is formed at the tongue portion upstream wall member 25 in the present embodiment, but may be a position further on the upstream side of the tongue portion upstream wall member 25 insofar as the position is a position where the dynamic pressure can be used, or may be at other wall members.

The cross flow fan described in each of the embodiments described above, the lift generation device including the cross flow fan, and the aircraft including the lift generation device are understood, for example, as follows.

The cross flow fan (3) according to an aspect of the present disclosure includes the plurality of vanes (15) disposed at predetermined intervals in the circumferential direction about the rotational axis (01), the tongue portion (17) disposed on an outer circumferential side of the vane (15), and the jetting portion (20) that jets a fluid along a wall surface of the discharge flow path to which the fluid is discharged from each of the vanes (15).

The cross flow fan forms a flow so as to intersect the plurality of vanes provided in the circumferential direction by forming the circulation vortex on an inner circumferential side of the vane and a tongue portion side of the rotational axis.

The jetting portion that jets a fluid along a wall surface of the discharge flow path to which the fluid is discharged from the vanes is provided. Accordingly, a flow can be formed in the fluid loss region formed in the vicinity of the wall surface of the discharge flow path, and a fluid loss can be reduced as much as possible.

Further, in the cross flow fan (3) according to the aspect of the present disclosure, the facing wall member (23) provided at a position facing the tongue portion (17) with each of the vanes (15) interposed therebetween is included, the facing wall member (23) includes the upstream wall member (28) that has an equivalent curvature radius with the outer circumference of the trajectory formed when each of the vanes (15) rotates, the downstream wall member (29) that is connected to the upstream wall member (28) and that has a curvature radius becoming gradually larger than that of the upstream wall member (28), and the diffuser wall member (30) connected to the downstream wall member (29), and the jetting portion (32) is provided at the downstream wall member (29).

A flow path is formed by the facing wall member provided at a position facing the tongue portion. The facing wall member includes the upstream wall member, the downstream wall member, and the diffuser wall member. Since the upstream wall member has an equivalent curvature radius with the outer circumference of the trajectory formed when the vanes rotate, the gap between the outer circumferences of the vanes and the upstream wall member is constant, and the loss of a fluid in this region is small. However, since the downstream wall member connected to the upstream wall member has a curvature radius becoming gradually larger than that of the upstream wall member, the gap between the outer circumferences of the vanes and the downstream wall member gradually increases. For this reason, there is a possibility that a fluid loss increases in the downstream wall member. Thus, the jetting portion that jets a fluid along a wall surface of the downstream wall member is provided, and the fluid loss is reduced.

Further, in the cross flow fan (3) according to the aspect of the present disclosure, the facing wall member (23) provided at a position facing the tongue portion (17) with each of the vanes (15) interposed therebetween is included, the facing wall member (23) includes the upstream wall member (28) that has an equivalent curvature radius with the outer circumference of the trajectory formed when each of the vanes (15) rotates, the downstream wall member (29) that is connected to the upstream wall member (28) and that has a curvature radius becoming gradually larger than that of the upstream wall member (28), and the diffuser wall member (30) connected to the downstream wall member (29), and the jetting portion (34) is provided at the diffuser wall member (30).

A flow path is formed by the facing wall member provided at a position facing the tongue portion. The facing wall member includes the upstream wall member, the downstream wall member, and the diffuser wall member. The diffuser wall member is connected to the downstream wall member, and has a curvature radius that is even larger than the downstream wall member in order to perform pressure recovery. For this reason, there is a possibility that delamination of a flow occurs in the vicinity of the wall member of the diffuser wall member and that a fluid loss increases. Thus, the jetting portion that jets a fluid along the wall surface of the diffuser wall member is provided, and the fluid loss is reduced.

Further, in the cross flow fan (3) according to the aspect of the present disclosure, the jetting portion (36) is provided on the tongue portion downstream wall member (26) that is connected to the tongue portion (17) and that extends to the downstream side.

There is a possibility that a fluid loss increases in the vicinity of the tongue portion downstream wall member that is connected to the tongue portion and that extends to the downstream side because of the effect of the circulation vortex. Thus, the jetting portion that jets a fluid along the wall surface of the tongue portion downstream wall member is provided, and the fluid loss is reduced.

Further, in the cross flow fan (3) according to the aspect of the present disclosure, a fluid compression portion that compresses a fluid supplied to the jetting portion (20) is included.

A compressed fluid generated by the fluid compression portion is supplied to the jetting portion. Examples of the fluid compression portion include a dedicated air compressor and an air compressor that supplies compressed air to an engine.

Further, in the cross flow fan (3) according to the aspect of the present disclosure, the fluid introduction inlet (40) formed on the upstream side from the vanes (15) is included, and a fluid introduced from the fluid introduction inlet (40) is guided to the jetting portion (36).

By forming the fluid introduction inlet on the upstream side from the vane, a fluid is introduced. The fluid can be introduced from the fluid introduction inlet using a dynamic pressure in the case of a moving body such as an aircraft. Since the fluid introduced from the fluid introduction inlet is jetted from the jetting portion, it is not necessary to generate power, which generates a high-pressure fluid. For this reason, an additional structure is unnecessary, and thus the weight can be reduced.

For example, in a case where the tongue portion upstream wall member is provided on the upstream side of the tongue portion, it is preferable to provide the fluid introduction inlet in the tongue portion upstream wall member.

In addition, the lift generation device according to another aspect of the present disclosure includes the cross flow fan (3) provided at a position where a flow flowing on a main body outer surface is sucked.

As the cross flow fan sucks a flow flowing on the main body outer surface, the delamination of a fluid flowing on the main body outer surface can be suppressed, and a lift feature can be improved.

In addition, the aircraft (1) according to still another aspect of the present disclosure includes the lift generation device.

Since the lift generation device using the cross flow fan is included, high lift can be realized by omitting a lift generation device such as a flap of the related art. The lift generation device can be provided, for example, at a trailing edge portion of a main wing and a fuselage rear portion.

The lift generation device can also be applied to wings of an aerodynamic device such as wings of a windmill or can also be applied to wings of a hydraulic device such as wings of a hydrofoil, in addition to an aircraft.

### REFERENCE SIGNS LIST

1: aircraft
3: cross flow fan
5: fuselage
7: main wing
8: horizontal stabilizer
9: vertical stabilizer
11: compressed air supply passage
12: suction port
13: discharge port
15: vane
17: tongue portion
19: frame body
20: jetting portion
22: tongue portion side wall member
23: facing wall member
25: tongue portion upstream wall member
26: tongue portion downstream wall member
28: upstream wall member
29: downstream wall member
30: diffuser wall member
32: first jetting portion (jetting portion)
34: second jetting portion (jetting portion)
36: third jetting portion (jetting portion)
40: fluid introduction inlet
O1: rotational axis (of vane)
R1: rotation direction (of vane)
V1: circulation vortex

1. A cross flow fan comprising:
a plurality of vanes that are disposed at a predetermined interval in a circumferential direction about a rotational axis;
a tongue portion that is disposed on an outer circumferential side of the vane; and
a jetting portion that jets a fluid along a wall surface of a discharge flow path to which the fluid is discharged from each of the vanes.

2. The cross flow fan according to claim 1, further comprising:
a facing wall member that is provided at a position facing the tongue portion with each of the vanes interposed therebetween,
wherein the facing wall member includes an upstream wall member that has an equivalent curvature radius with an outer circumference of a trajectory formed when each of the vanes rotates, a downstream wall member that is connected to the upstream wall member and that has a curvature radius becoming gradually larger than that of the upstream wall member, and a diffuser wall member that is connected to the downstream wall member, and
the jetting portion is provided on the downstream wall member.

3. The cross flow fan according to claim 1, further comprising:
a facing wall member that is provided at a position facing the tongue portion with each of the vanes interposed therebetween,
wherein the facing wall member includes an upstream wall member that has an equivalent curvature radius with an outer circumference of a trajectory formed when each of the vanes rotates, a downstream wall member that is connected to the upstream wall member and that has a curvature radius becoming gradually larger than that of the upstream wall member, and a diffuser wall member that is connected to the downstream wall member, and
the jetting portion is provided on the diffuser wall member.

4. The cross flow fan according to claim 1,
wherein the jetting portion is provided on a tongue portion downstream wall member that is connected to the tongue portion and that extends to a downstream side.

5. The cross flow fan according to claim 1, further comprising:
a fluid compression portion that compresses the fluid supplied to the jetting portion.

6. The cross flow fan according to claim 1, further comprising:
a fluid introduction inlet that is formed on an upstream side from the vanes,
wherein the fluid introduced from the fluid introduction inlet is guided to the jetting portion.

7. A lift generation device comprising the cross flow fan according to claim 1 that is provided at a position where a flow flowing on a main body outer surface is sucked.

8. An aircraft comprising the lift generation device according to claim 7.
